(19) United States
(12) Patent Application Publication
(10) Pub. No.: US 2024/0046351 A1
(43) Pub. Date: Feb. 8, 2024

(54) METHODOLOGY FOR PROCESSING MONTHLY PAYMENTS

(71) Applicant: Eric Ostergren, Roscommon, MI (US)

(72) Inventor: Eric Ostergren, Roscommon, MI (US)

(21) Appl. No.: 18/491,159

(22) Filed: Oct. 20, 2023

Related U.S. Application Data
(63) Continuation-in-part of application No. 17/471,239, filed on Sep. 10, 2021.
(60) Provisional application No. 63/093,457, filed on Oct. 19, 2020.

(51) Int. Cl. G06Q 40/03; G06Q 20/02

(52) U.S. Cl. CPC G06Q 40/03; G06Q 20/023

(57) ABSTRACT

The present invention provides for a business process, method, and system that shall work with most any monthly payment obligation like a mortgage or installment loan; it collects smaller weekly, every two weeks, or twice monthly debits starting on the first or next monthly due date, then the full monthly payment is applied in arrears when sufficient funds are collected; the lender would offer this service as a courtesy to help the consumer and as a competitive feature and would in most cases also lower their regular check payment processing costs which can range from $1.50 to $5.00. The present invention will allow those lenders to keep their existing infrastructures in place and offer our solution as an option. The lender sacrifices very little and benefits greatly. If the consumer defaults on the automated collection process, it simply reverts to the or

### CROSS REFERENCE TO RELATED APPLICATION

Cross referenced to Provisional Patent Application 63/093,457, and utility patent application Ser. No. 17/471,239.

### STATEMENT REGARDING FEDERALLY SPONSORED RESEARCH OR DEVELOPMENT

Not Applicable

### BACKGROUND

The present invention provides for a business process, method that shall work with any monthly payment obligation like a mortgage or installment loan. There are many advantages the invention has over existing more frequently than Monthly Payment Collection Systems (MFM) for monthly fixed payment obligations. Other MFM's collect what is owed for the full monthly payment in advance of the full monthly payment due date whereas the present invention collects smaller weekly, every two weeks, or twice monthly debits starting on the first (or next monthly due date), then the full monthly payment is applied after the first (or next monthly due date) is due (in arrears) when sufficient funds are collected. The lender would offer this service as a courtesy to help the consumer and as a competitive feature. In most cases it would also lower the lenders regular check payment processing costs which can range from $1.50 to $5.00. The invention collects payments via the Automated Clearing House (ACH), which costs much less (between $0.05 and $0.10) per payment.

Most consumers are paid weekly, every two weeks or twice a month. Smaller, automated (collected from checking accounts) payments that align more closely with the way consumers are paid will make it easier and more likely to be collected. This will be beneficial to both the lender and consumer.

Currently, all more frequently than monthly (weekly, every two weeks or twice a month) payment collection payment systems are processed by third party administrators who do not have a direct association with lenders. These third party administrators collect payments in advance of the monthly due date because the full monthly payment must be paid on the lenders due date. Making payments in advance of the monthly due date creates a problem for consumers because they have to set aside funds in advance of when they are due which creates a cash flow problem for the consumer. If lenders provided this service, it would create a legal problem for them because it violates Truth in Lending rules and regulations.

The present invention is an improvement in the existing prior art as the present invention collects the payments in arrears which is easier for the consumer to pay and understand and the lender bears the lost interest income from not collecting the full monthly payment on its due date. It does not violate Truth in Lending rules and the unique process does not affect the actual interest rate cost to the consumer. The low cost to the lender is outweighed by the competitive offering advantages and increased likelihood of collecting smaller, automated, incremental payments versus the larger, full monthly payment which reduces loan defaults and this novelty in the invention shall be noticeable to the person skilled in the art.

### BRIEF DESCRIPTION OF THE INVENTION

The present invention provides for a business process, method and system that shall work with most any monthly payment obligation like a mortgage or installment loan. There are many advantages the invention has over existing more frequently than Monthly Payment Collection Systems (MFM) for monthly fixed payment obligations. Other MFM's collect what is owed for the full monthly payment in advance of the full monthly payment due date whereas the present invention collects smaller weekly, every two weeks, or twice monthly debits starting on the first or next monthly due date, then the full monthly payment is applied in arrears when sufficient funds are collected. The lender would offer this service as a courtesy to help the consumer and as a competitive feature. In most cases it would also lower their regular check payment processing costs which can range from $1.50 to $5.00. The invention collects payments via the Automated Clearing House (ACH), which costs much less (between $0.05 and $0.10) per payment.

The invention works in conjunction with the lenders monthly payment infrastructure which remains in place in the event the consumer abandons the MFM payment. In other words, the MFM payment plan is always used at the consumer's option. Conventional MFM's require half of a payment to be made every two weeks (or a quarter payment every week) and a full monthly payment is required to be collected before the monthly payment is due in order to make every full monthly payment in full and on time. This results in an extra monthly payment being made every year which pays the loan off early and saves interest. The downside for the consumer is that it increases their cash outlay each month and the enrollment cost is prohibitive and rarely saves enough interest to make up for the enrollments cost. With prevailing interest rates being so low and the costs of the MFM program being so high, the consumer realizes little or no financial advantage and the FTC started looking closely at these programs as an Unfair Trade Practice. Something was needed that benefited the consumer and the lender and the invention evolved as a result. For example, a $400 monthly payment with a 60 month term would total $24,000 in payments. However, that same $24,000 divided by actual every two weeks or weekly periods would result a much smaller amount than half of the monthly payment ($200) that conventional MFM's collect. The invention only collects a every two weeks payment of $184.62 or a weekly payment of $92.31. The resolution was simple but unobvious as it had never been done before. Lenders do not have the capability, knowhow, software, and more importantly the desire to change collection methodologies which the invention does.

The present invention eliminates all the negative issues regarding the conventional MFM payment processes described above. Consumers want lower payment options and like the convenience and simplicity of payday payments and that is what the present invention does. Indirect lenders, like automobile dealerships, want to present smaller payments to help them sell more and lenders want competitive advantages to sell more financing contracts and improve collections, which reduce defaults. The major difference between conventional MFM's and the invention is that whatever payday option is selected, the first debit is collected on the same day the first monthly payment would normally be collected, not ahead of time as with conventional MFM programs. That makes it simple to explain to the consumer.

The major component of the present invention is that the invention's partial payments are much smaller than conventional MFM methods or any other payment option. These partial payments are also much less than the consumer expects which makes selling products much easier. As an example, if the consumer had a $400 monthly payment, they would normally set aside $100 every week or $200 every two weeks depending on how they were paid which is the same amount the MFM collects (without their collection fee). However, the inventions payment is reduced to a weekly payment of $92.31 ($400/month times 12 months=$4,800 divided by 52 weeks equals $92.31) and a every two weeks payment is reduced to $184.62 ($400/month times 12 months=$4,800 divided by 26 every two weeks periods equals $184.62). These payments are more attractive as opposed to a large monthly payment for consumers that are paid weekly and every two weeks.

The partial payments are accumulated in a separate account held by the lender and the full monthly payment is credited to the consumer's loan when a full monthly payment accumulates. The consumer's monthly contract remains in place and is not disturbed.

The invention would be an optional addendum the consumer would enroll in. Since this would be offered by the lender, a flag would be placed on the consumer's monthly contract because the monthly payment would not be paid on the original due date. The lost interest cost would be minimal and the benefits to the lender would substantially outweigh the lost interest cost. For example; if the cost of money were 5% to the lender and the monthly payment was $400 the average cost would only be $0.77/month. That number is assuming that the consumer made their monthly payment on time every month and was never late (or paid within the grace period).

The partial payments are collected via ACH (which cost banks between $0.05 and $0.10) and processing paper checks cost $1.50 or more. This means the present invention would be much less expensive for banks to use and loan defaults should decrease because smaller payments automatically collected from their checking account on or shortly after their paydays are much more likely to be collected as opposed to a large monthly payment that the consumer needs to consciously save towards and make every month.

Most all current loan repayment infrastructures lenders (loan, lease, etc.) are designed to only accept monthly payments. The present invention will allow those lenders to keep their existing infrastructures in place and offer our solution as an option. The lender sacrifices very little and benefits greatly. If the consumer defaults on the automated collection process, it simply reverts to the original monthly contract.

The procedure of working of the system is as follows:
1. The consumer would enroll in our Optional Partial Payment Agreement (“OPPA”) with the lender (payee) as a method for collecting Partial Payments (“PP”) on their existing (or proposed) monthly obligation (usually a loan or lease) towards the Full Monthly Payment Contract (“FMPC”).
2. The consumer can revert to the FMPC obligation at any time.
3. The consumer would need to provide all their necessary information to process the OPPA to complete the collection of the PP's, including their bank routing and account information, etc.
4. The original FMPC would remain in place as well as the lender's legacy accounting infrastructure.
5. The lender would then flag the FMPC as being under an OPPA to accept the Full Monthly Payments (“FMP”) at different times than the FMPC provided, so they would not be flagged as having a late payment because the PP's are not applied to the FMPC when received and the FMP is applied at different time than the original due dates provided in the FMPC.
6. A Separate Accounting Payment System (“SAPS”) (separate from the lenders legacy system) would process and account for the PP's in a Separate Account (“SA”) for each OPPA.
7. The first PP would be collected on the same date agreed to in the FMPC for the FPM. This is the unique aspect of this business process and what makes it attractive to the consumer.
8. This and following PP's would be set aside in the SAPS for each individual account.
9. When the SA has accumulated enough to make a FMP, it would be applied to the FMPC in the lenders legacy system.
10. Amounts in excess of the FMP remaining in the SA would remain to be applied to the next FMP.
11. This process would repeat itself until the FMPC obligation was completed or terminated.

The present system would have to be used by a loan or lease originator. They would have to develop specialized calendaring programs to know when to pull PP's and when to pay FM P's to the lenders and have a understanding of properly dividing the FMP so the FMP is applied to the FMP obligation. It would also require expansive knowledge on how the Automated Clearing House (ACH) system works. The Lender would also need to develop policies on Non-Sufficient Funds (NSF's), etc. and what to do when one occurs. They would have to develop an accounting system that would accommodate the calendaring and accounting necessary to do so.

### BRIEF DESCRIPTION OF THE DRAWINGS

FIG. 1 represents the flowchart of the working of the system

### DETAILED DESCRIPTION OF THE DRAWINGS

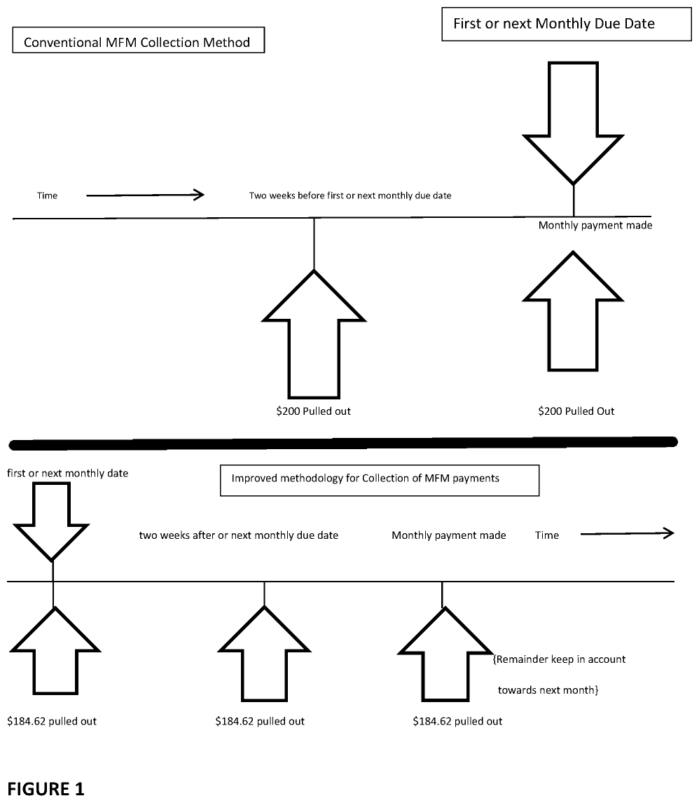

FIG. 1 represents the flowchart of the working of the system.

What is claimed for is:

1.-5. (canceled)

6. The system as claimed in claim 8, further comprising: collecting said smaller payments via Automated Clearing House or other electronic payment processing system.

7. The system as claimed in claim 8, further comprising: integrating an agreement associated with the selected option with said lenders existing monthly payment infrastructure.

8. A system for calculating an optional partial payment agreement, said system comprising:
A) a consumer receives a monthly payment obligation for a mortgage or loan from a lender which requires a full monthly payment on a certain due date;
B) said lender provides an option to convert said full monthly payment obligation into a smaller payment selected from
i) a weekly payment,
ii) a bi-weekly payment,
iii) a twice monthly payment;
C) said consumer selects one of said smaller payment options to be collected starting on an original full monthly due date which initiates an enrollment in lender's optional partial payment agreement;
D) said smaller payment is collected by lender and set aside in a separate account for said consumer until a full monthly payment is collected;
E) said consumer provides a bank routing and account information to said lender and said lender flags said payment in said lenders existing monthly payment infrastructure;
F) said smaller payment is applied to said full monthly payment obligation under said agreement;
G) wherein any excess funds remaining beyond said full monthly payment obligation are further applied to a next full monthly payment obligation until all obligations are met or terminated.
